(19) United States
(12) Patent Application Publication
(10) Pub. No.: US 2026/0072197 A1
(43) Pub. Date: Mar. 12, 2026

(54) COMBINED SATELLITE AND MOBILE WEATHER FORECASTING SYSTEM FOR DATA DENIED ENVIRONMENTS AND RELATED METHODS

(71) Applicant: ACME ATRONOMATIC, LLC, Orlando, FL (US)

(72) Inventor: SARVESH GARIMELLA, Portland, OR (US)

(21) Appl. No.: 19/323,069

(22) Filed: Sep. 9, 2025

Related U.S. Application Data
(60) Provisional application No. 63/692,978, filed on Sep. 10, 2024.

(51) Int. Cl. G01W 1/10; G01W 1/00; G01W 1/06

(52) U.S. Cl. CPC G01W 1/10; G01W 1/06; G01W 2001/006

(57) ABSTRACT

A combined satellite and mobile weather forecasting system may include a satellite payload having a plurality of sensors configured to capture atmospheric and environmental data including atmospheric radiances and vertical soundings and a receiver for receiving data from other satellites. The satellite payload may also include a processing unit configured to condense the captured atmospheric and environmental data and the received data from other satellites into initialization data to generate a weather forecast. The satellite payload may include a transmission device configured to communicate with a mobile cellular device and to transmit the initialization data. The mobile cellular device may be configured to receive the initialization data from the transmission device of the satellite payload to generate the weather forecast using the initialization data.

### RELATED APPLICATIONS

This application claims the benefit of U.S. Provisional Application Ser. No. 63/692,978 filed Sep. 10, 2024, which is hereby incorporated herein in its entirety by reference.

### TECHNICAL FIELD

The present invention relates to weather forecasting systems and methods, and more particularly, to a combined satellite and mobile weather forecasting system for data denied environments and related methods.

### BACKGROUND

Traditional weather forecasting systems rely on large amounts of data transmitted continuously from satellites to ground stations, where complex models are run on powerful computers. These systems, while accurate, are resource-intensive and require substantial infrastructure. Emerging deep learning models offer the potential to perform weather forecasting on less powerful devices, such as mobile phones.

The initial conditions used for a Numerical Weather Prediction (NWP) model are a detailed representation of the atmosphere's state at the start of the forecast period. These conditions are derived from various observational data sources and may be important for the accuracy of the forecast.

These initial conditions are obtained through a process called data assimilation, which integrates observational data from various sources, such as weather stations, satellites, radars, and radiosondes, with model data. Data assimilation uses mathematical techniques to combine the observations with prior model forecasts to produce the best estimate of the current atmospheric state.

The resulting initial conditions provide the starting point for the NWP model's simulation, allowing it to project the future state of the atmosphere by solving the governing equations of fluid dynamics, thermodynamics, and other physical processes. Accurate and geophysically balanced initial conditions may be important for producing reliable weather forecasts.

However, the challenge remains to efficiently transmit the necessary initialization data to mobile devices to enable accurate forecasts.

### SUMMARY

A combined satellite and mobile weather forecasting system includes a satellite payload that includes a plurality of sensors configured to capture atmospheric and environmental data comprising atmospheric radiances and vertical soundings and a receiver for receiving data from other satellites. The satellite payload also includes a processing unit configured to condense the captured atmospheric and environmental data and the received data from other satellites into initialization data to generate a weather forecast. The satellite payload includes a transmission device configured to communicate with a mobile cellular device and to transmit the initialization data. The system includes a mobile cellular device configured to receive the initialization data from the transmission device of the satellite payload using a mobile receiver, and to generate the weather forecast using the initialization data.

A method aspect is directed to weather forecasting and may comprise operating a plurality of sensors of a satellite payload to capture atmospheric and environmental data comprising atmospheric radiances and vertical soundings. The method may also include operating a receiver for receiving data from other satellites. In addition, the method may include operating a processing unit to condense the captured atmospheric and environmental data and the received data from other satellites into initialization data to generate a weather forecast. The method may include operating a transmission device to communicate with a mobile cellular device and to transmit the initialization data. The method may include receiving the initialization data from the transmission device of the satellite payload at a mobile cellular device and using the mobile cellular device to generate the weather forecast using the initialization data.

### BRIEF DESCRIPTION OF THE DRAWINGS

FIG. 1 is a schematic illustrating a satellite payload having a plurality of sensors, an onboard processing unit, and a transmission module in accordance with a particular embodiment of the invention to generate a weather forecast;

FIG. 2 is a schematic illustrating a mobile cellular device of the system having a receiver, a processing unit, and a forecasting application;

FIG. 3 is a schematic diagram illustrating a method of collection, processing, and transmission of initialization data by a satellite payload in accordance with a particular aspect of the invention; and

FIG. 4 is a schematic diagram illustrating a method of receiving, processing, and generating a weather forecast using a forecasting application on the mobile cellular device.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The embodiments seek to address the above-identified challenges by departing from conventional forecasting architectures that rely on centralized ground stations and high-bandwidth transmission of full satellite datasets. In traditional systems, satellites capture radiance fields or soundings and downlink gigabytes of data to centralized facilities, where large-scale numerical weather prediction models are executed on supercomputers, with forecast products subsequently redistributed to end users. In sharp contrast, the present embodiments provide a system in which the satellite payload preprocesses its measurements, performs bias correction and data fusion, and may transmit only a compact initialization dataset to a mobile device. This initialization dataset is typically several orders of magnitude smaller than the raw measurements, but retains the important atmospheric state information used for forecast generation. The mobile device, which may be a smartphone, tablet, or ruggedized tactical handheld, then performs the forecasting computations locally.

In one approach, the device executes reduced-scale numerical weather prediction models, such as WRF or MPAS, configured with simplified physics schemes and smaller integration domains suitable for edge hardware. In another approach, the device executes deep learning models that have been pre-trained on reanalysis archives and satellite data and optimized for real-time inference on neural processing units. This architecture is in contrast to prior systems, which either treat mobile devices as thin clients for viewing pre-generated forecasts, or require bulky portable servers with high-bandwidth links. By recognizing that modern mobile devices now possess sufficient compute capability to perform forecast generation, and by pairing this with an innovative strategy of transmitting compressed initialization vectors rather than full observation sets, the embodiments create a bandwidth-efficient and resilient forecasting paradigm that is a significant improvement over existing systems and methods.

In particular, the embodiments are directed to a combined satellite and mobile weather forecasting system and method that is specifically configured to generate reliable forecasts at the edge in data-denied or bandwidth-constrained environments. The system includes a satellite component that acquires atmospheric and environmental data through one or more onboard sensing instruments, such as hyperspectral sounders, passive microwave radiometers, and scatterometers, and may further receive supplemental data relayed from external assets including other satellites, airborne platforms, or ground-based observation networks. The satellite component preprocesses this information using onboard computational resources to perform calibration, geolocation, data fusion, and bias correction, ultimately condensing the observations into a reduced, but information-rich initialization dataset, that captures the essential atmospheric state variables of temperature, humidity, wind, and pressure fields. These initialization parameters are then packaged and transmitted through an optimized downlink channel using compression and prioritization schemes designed to minimize data size while preserving the forecast-critical content.

On the user side, the mobile component receives this initialization dataset via a mobile receiver and processes it locally using its integrated computing hardware, which may include multi-core processors, graphics processing units, or dedicated neural processing accelerators. In one embodiment, the mobile component is equipped with the Android Team Awareness Kit (ATAK) framework, which provides a geospatially aware operating environment into which the forecast results can be directly integrated. By executing reduced-scale numerical weather prediction models, such as WRF or MPAS, or pre-trained deep learning models optimized for rapid inference, the mobile component generates real-time and short range predictive weather information directly at the point of need. Forecasts may include temperature trends, precipitation intensity, wind speed and direction, convective instability, and other mission critical parameters. Because the system uses only the low volume initialization dataset to be transmitted, rather than raw satellite observations or pre-computed forecast products, the bandwidth requirements are dramatically reduced, making the system particularly well suited for tactical, emergency response, agricultural, or environmental monitoring applications where connectivity is intermittent, degraded, or entirely absent.

The system and method increase the overall efficiency of weather forecasting by dramatically reducing the amount of data to be transmitted from orbiting satellites to mobile cellular devices. In conventional workflows, raw radiance data, hyperspectral soundings, or retrieval products can range from several gigabytes to terabytes per day per satellite, requiring continuous high-bandwidth downlinks and centralized supercomputing resources. By contrast, the present embodiments perform data fusion and preprocessing onboard the satellite, reducing these data streams to compact initialization datasets that are often two or three orders of magnitude smaller in volume. A typical initialization package may be on the order of 5 kilobytes to 50 megabytes, compared to gigabytes of unprocessed observations, allowing transmission to a handheld device in less than one minute even over constrained communication links. This reduction in bandwidth requirement directly enables operation in environments where high-capacity links are unavailable, intermittent, or intentionally disrupted. For example, an analog forecast may be represented by an index value, which can be stored or transmitted as a relatively small data element requiring minimal bandwidth. In certain embodiments, the data rates may be as low as approximately 1 kbps, and by transmitting only an index referencing a dataset entry, rather than transmitting the full dataset, the total amount of data transferred may be reduced to only a few kilobytes.

In particular, the embodiments increase accessibility by enabling accurate and timely weather forecasting in data-denied or degraded environments using only mobile cellular devices. Forecast generation no longer depends on continuous connectivity to central servers or access to HPC infrastructure, but instead occurs autonomously at the edge, close to the end user. The embodiments thereby extend forecasting capability to personnel in contested theaters, first responders in disaster-stricken regions, farmers in rural areas with poor connectivity, and researchers in remote field sites, for example.

The system and method substantially increase the efficiency of weather forecasting by minimizing the amount of data that is transmitted from spaceborne assets to mobile cellular devices. Conventional weather forecasting systems downlink raw radiance data, hyperspectral soundings, or bulk retrieval products in volumes that may reach gigabytes per orbit. Such transmission places heavy demands on satellite communication channels and ground infrastructure and may be impractical for dissemination to handheld devices in the field. In contrast, the present embodiments transmit only compact initialization parameters that encapsulate the essential atmospheric state for forecast generation. These initialization packages may be two to three orders of magnitude smaller than the original datasets, often in the range of only a few megabytes, and can therefore be transmitted rapidly over narrowband links or tactical communication channels. By lowering the bandwidth requirement so dramatically, the embodiments reduce both transmission costs and latency, while enabling weather forecasting capabilities in regions and scenarios where high-capacity communications are unavailable, unreliable, or intentionally disrupted.

The system and method have many potential applications across both civilian and defense domains, particularly in environments where traditional forecast products are unavailable or unreliable due to communication constraints. In government operations, for example, the embodiments enable forward-deployed units in remote or contested areas to generate localized weather forecasts on handheld devices without requiring access to centralized ground stations or high-bandwidth communication links. Such forecasts can inform mission planning by predicting precipitation that could affect visibility, wind shifts that could alter unmanned aerial system flight paths, or temperature extremes that could impact personnel and equipment readiness. The ability to integrate these forecasts directly into situational awareness platforms such as ATAK may ensure that environmental conditions are factored into operational decision-making in real time.

In emergency response and disaster management scenarios, the embodiments provide responders with rapid, localized forecasts when infrastructure is damaged or destroyed. Following hurricanes, earthquakes, or wildfires, communication networks are often disrupted, leaving first responders without access to conventional forecast updates. By transmitting compact initialization data from satellites and enabling forecasts to be generated at the edge on mobile devices, the embodiments allow responders to anticipate evolving hazards such as flash flooding, storm surges, or shifting wind patterns that could spread wildfires. This capability supports faster, more effective resource allocation and evacuation planning.

In agricultural planning and management, the embodiments enable farmers in rural regions with limited connectivity to access high-resolution weather forecasts directly on mobile devices. Forecasts of rainfall, temperature, and soil moisture trends can inform irrigation scheduling, pesticide and fertilizer application, and harvest planning, reducing crop losses and improving yields. Because the system uses low-bandwidth transmission of initialization data rather than continuous connectivity to central forecast services, it is particularly suited for regions where broadband internet access is sparse or unreliable.

In environmental monitoring and research applications, the system provides scientists and field researchers with real-time forecast tools while conducting operations in remote locations such as polar regions, deserts, or oceans. For instance, researchers aboard ships can use the system to anticipate changes in sea state or ice drift, while ecologists in remote field stations can track localized convective storms or temperature anomalies that may affect ecosystems under study. The autonomous nature of the forecasting capability may ensure that data can be generated and visualized even in complete communication blackouts, enabling continuous situational awareness in some of the most data-denied environments on Earth.

Collectively, these applications illustrate the versatility and operational value of the embodiments. By coupling satellite-side data reduction with mobile-edge forecast generation and visualization, the system and method may extend accurate, actionable weather intelligence to users who were previously constrained by bandwidth limitations, central infrastructure requirements, or geographic isolation.

Referring now to the drawings, the present embodiments are directed to a combined satellite and mobile weather forecasting system and method configured to minimize data transmission requirements while enabling accurate forecasting in data-denied environments. The system may achieve this by transmitting only initialization data, in highly compressed form, from a satellite platform to a mobile computing device. The mobile device then performs the bulk of the forecasting computations locally, either using traditional numerical weather prediction (NWP) models or using advanced machine learning and deep learning models. By offloading the forecasting computation to the edge, the system capitalizes on the increasing processing power of modern mobile devices and allows end users to generate real-time and predictive weather information without requiring high-bandwidth satellite downlinks.

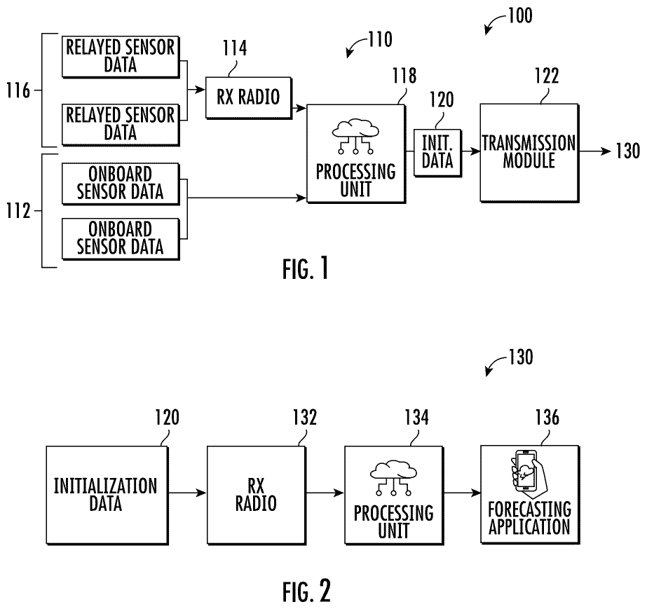

As shown in FIGS. 1 and 2, the system 100 includes a satellite payload 110 that is equipped with a plurality of atmospheric and environmental sensors 112. These sensors may include radiometers, spectrometers, hyperspectral sounders, scatterometers, and microwave imagers capable of observing a variety of atmospheric parameters. In particular embodiments, the sensors 112 capture top-of-atmosphere radiances at multiple wavelengths and vertical profiles of temperature, moisture, and wind velocity. Hyperspectral atmospheric sounding is preferably employed to provide fine vertical resolution of temperature and moisture profiles throughout the troposphere and lower stratosphere.

In addition to its own onboard sensors, the satellite payload 110 further includes a receiver 114 that is configured to relay external data 116 collected by other spaceborne or airborne assets. For example, the receiver 114 may ingest data streams from partner satellites, including radiance retrievals, microwave sounding units, or lidar-based wind observations. By incorporating these external inputs, the satellite payload 110 expands the spatial and temporal coverage of observations available to the system 100.

A processing unit 118 onboard the satellite condenses and refines the sensor data into a set of initialization data 120 suitable for weather model initialization. The processing unit 118 may employ data fusion algorithms to merge observations from multiple instruments and platforms into a coherent representation of the atmospheric state. Bias correction algorithms may be applied to correct for systematic measurement errors. In certain embodiments, the processing unit 118 may also blend the satellite-derived observations with global NWP analysis fields available from large-scale forecast centers, thereby mimicking a data assimilation cycle in compressed form. This allows the initialization data 120 to preserve large-scale atmospheric context while capturing high-resolution local observations.

Once prepared, the initialization data 120 is transmitted to ground users via a transmission module 122. The transmission module 122 may be optimized for low-bandwidth communication, implementing efficient encoding and compression techniques to minimize data size without sacrificing important information content. For example, the transmission module 122 may employ lossless compression, variable bit-rate encoding, indexing, or selective prioritization of parameters based on forecast sensitivity analysis. In this manner, a relatively small initialization package can contain sufficient atmospheric state information for the mobile device to generate forecasts locally.

On the user side, the system 100 further includes a mobile cellular device 130, which may take the form of a smartphone, tablet, or ruggedized handheld computing platform. In a particular aspect, the mobile device 130 is integrated with the ATAK (Android Team Awareness Kit) framework, enabling seamless visualization and operational integration of weather data alongside mission planning and situational awareness functions.

The mobile device 130 incorporates a mobile receiver 132 configured to acquire the initialization data 120 transmitted from the satellite payload 110. A mobile processing unit 134 is then configured to execute a weather forecasting application 136 that ingests the initialization data 120 and produces short-term and medium-term forecasts. The forecasting application 136 provides a user-friendly interface with graphical visualization of meteorological parameters such as wind speed, precipitation, cloud cover, and temperature. Forecast outputs may be overlaid on maps, tactical imagery, or geographic information system (GIS) layers, thereby supporting decision-making in real time.

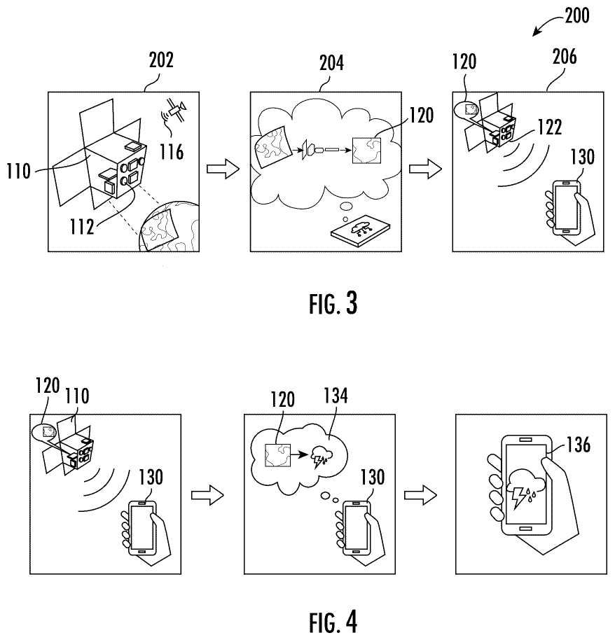

Referring to FIG. 3, a schematic diagram of a satellite-side method 200 is shown. The method includes collection 202 of atmospheric data by the satellite payload sensors 112 and receiver 114, processing 204 of the collected data by the onboard processing unit 118 into initialization data 120, and transmission 206 of the initialization data 120 to a mobile device via the transmission module 122.

Referring now to FIG. 4, a schematic diagram of a mobile-side method 300 is shown. The method includes receiving 208 initialization data at the mobile receiver 132, processing 210 the initialization data locally within the mobile processing unit 134, and generating a weather forecast using a forecasting application 212. The mobile forecasting process may include data assimilation, model integration, and visualization steps tailored for resource constrained environments.

Two forecasting approaches are supported by the forecasting application 136. In a first approach, the mobile device executes traditional numerical weather prediction (NWP) models. These models solve partial differential equations governing atmospheric dynamics and thermodynamics using finite-difference or finite volume schemes. Representative models include the Weather Research and Forecasting (WRF) model and the Model for Prediction Across Scales (MPAS). The initialization data 120 provides the initial and boundary conditions necessary to run these models in a localized forecast domain.

In a second approach, the forecasting application 136 executes one or more deep learning models trained to predict atmospheric states from initialization vectors and observational data. These models may be convolutional neural networks (CNNs), recurrent neural networks (RNNs), or transformer-based architectures trained on historical reanalysis data combined with real-time satellite observations. The deep learning models are capable of learning non-linear relationships and capturing fine scale weather patterns that may be underrepresented in traditional NWP. The models can be optimized for rapid inference on mobile processors, enabling near real-time forecast generation.

The combined satellite and mobile system thus provides a highly efficient weather forecasting architecture. By transmitting only initialization data, rather than complete raw sensor datasets, the bandwidth used between the satellite and the end user is dramatically reduced. The mobile device then uses its computational capabilities to generate full forecast products, providing a practical and scalable approach for operations in bandwidth-constrained or denied environments.

In summary, the combined satellite and mobile weather forecasting system provides an architecture that leverages both spaceborne sensing and mobile edge computation. By optimizing the division of tasks between the satellite and the mobile device, the system may reduce data transmission requirements while enabling accurate, accessible, and timely weather forecasts across a wide range of applications.

The present embodiments depart significantly from existing weather forecasting architectures. Conventional systems rely on centralized, high-performance computing (HPC) resources to assimilate raw satellite observations into large-scale numerical weather prediction (NWP) models. These traditional workflows require the transmission of complete radiance fields, soundings, or derived products from satellites to centralized ground stations, where forecasts are generated and subsequently disseminated to end users. Such an approach consumes substantial bandwidth, introduces latency, and is impractical in bandwidth-denied environments.

In contrast, the present embodiments introduce a division of computational labor between satellite platforms and mobile edge devices. Rather than transmitting voluminous raw sensor outputs, the satellite payload processes the observational data into compact initialization vectors that retain the essential atmospheric state information required for forecast generation. These vectors are highly compressed relative to the original datasets and are optimized for minimal bandwidth transmission, representing a fundamental departure from conventional architectures.

Furthermore, the present embodiments incorporate a hybrid assimilation approach whereby the satellite payload blends its observations with available large-scale NWP fields prior to compression and transmission. This blending mimics aspects of centralized data assimilation but relocates it to the spaceborne platform, allowing the mobile device to benefit from both local observations and global model context with only a fraction of the data volume. Such an onboard fusion step is distinct from standard practice, which relies on centralized ground-based assimilation systems.

Existing “mobile weather apps” operate purely as thin clients, displaying centrally computed forecasts. Similarly, prior government or tactical weather systems have required either bulky portable servers or high-bandwidth downlinks to receive processed forecasts. None have contemplated the specific workflow of satellite-generated initialization packages and mobile-executed forecasting. This architecture is a significant improvement because it identifies the bandwidth bottleneck as the limiting factor, reconceives the mobile device as a forecast generator rather than a passive consumer, and leverages emerging mobile hardware capabilities.

Another advantage is the satellite-side data fusion and assimilation step, which blends direct satellite observations with external datasets and global model fields before transmission. This may ensure that the initialization vectors retain both local high-resolution information and large-scale synoptic context, thereby improving the quality of forecasts generated on the mobile device. Conventional approaches typically rely exclusively on ground-based assimilation centers for this step and do not contemplate performing such blending onboard the satellite itself.

Collectively, these advantages provide a robust and improved approach for weather forecasting in data-denied environments. The system achieves bandwidth efficiency, edge-based forecast generation, support for both NWP and deep learning models, onboard data fusion at the satellite, and tactical integration with mission-critical frameworks.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A combined satellite and mobile weather forecasting system, the system comprising:
a satellite payload comprising,
a plurality of sensors configured to capture atmospheric and environmental data including atmospheric radiances and vertical soundings,
a receiver for receiving data from other satellites,
a processing unit configured to condense the captured atmospheric and environmental data and the received data from other satellites into initialization data to generate a weather forecast, and
a transmission device configured to transmit the initialization data; and
a mobile cellular device comprising,
a mobile receiver configured to receive the initialization data from the transmission device of the satellite payload, and
a mobile processing unit configured to run a forecasting application to generate the weather forecast using the received initialization data.

2. The system of claim 1, wherein the mobile the forecasting application comprises a user interface for real-time weather updates, historical data, and predictive analytics.

3. The system of claim 1, wherein the processing unit of the satellite payload is configured to perform data fusion and bias correction algorithms to increase an accuracy of the initialization data.

4. The system of claim 1, wherein the processing unit of the satellite payload is further configured to blend the captured atmospheric and environmental data with large-scale numerical weather prediction model data to generate the initialization data.

5. The system of claim 1, wherein the mobile processing unit is configured to execute a numerical weather prediction model comprising at least one of a Weather Research and Forecasting (WRF) model and a Model for Prediction Across Scales (MPAS).

6. The system of claim 1, wherein the forecasting application comprises a deep learning model trained on historical satellite data and reanalysis datasets.

7. The system of claim 1, wherein the mobile cellular device further comprises another processing unit configured to accelerate execution of the forecasting application.

8. The system of claim 1, wherein the initialization data comprises vertical profiles of temperature, humidity, and wind.

9. The system of claim 1, wherein the satellite payload is configured to transmit the initialization data using a low-bandwidth communication protocol.

10. The system of claim 1, wherein the mobile cellular device is further configured to share the weather forecast with other mobile cellular devices through a peer-to-peer mesh network.

11. The system of claim 1, wherein the plurality of sensors of the satellite payload comprises at least one hyperspectral sounder, microwave radiometer, or scatterometer.

12. A mobile cellular device for generating a weather forecast, the mobile cellular device comprising:
a mobile receiver configured to receive initialization data transmitted from a satellite payload; and
a mobile processing unit configured to run a forecasting application to generate the weather forecast using the received initialization data.

13. The mobile cellular device of claim 12, wherein the forecasting application comprises a numerical weather prediction model configured to simulate atmospheric processes using the initialization data.

14. The mobile cellular device of claim 12, wherein the forecasting application comprises a deep learning model trained on historical satellite data and reanalysis datasets.

15. The mobile cellular device of claim 12, comprising another processing unit configured to accelerate execution of the forecasting application.

16. A method for generating a weather forecast, the method comprising:
operating a plurality of sensors of a satellite payload to capture atmospheric and environmental data including atmospheric radiances and vertical soundings;
operating a receiver for receiving data from other satellites;
operating a processing unit to condense the captured atmospheric and environmental data and the received data from other satellites into initialization data to generate a weather forecast;
operating a transmission device to communicate with a mobile cellular device and to transmit the initialization data;
receiving the initialization data from the transmission device of the satellite payload at a mobile cellular device; and
using the mobile cellular device to generate the weather forecast using the initialization data.

17. The method of claim 16, wherein operating the processing unit comprises performing data fusion and bias correction to increase accuracy of the initialization data.

18. The method of claim 16, wherein using the mobile cellular device to generate the weather forecast comprises executing a numerical weather prediction model.

19. The method of claim 16, wherein using the mobile cellular device to generate the weather forecast comprises executing a deep learning model on the mobile cellular device.

20. The method of claim 16, wherein the initialization data comprises vertical profiles of temperature, humidity, and wind.
